(19) United States
(12) Patent Application Publication
(10) Pub. No.: US 2024/0265900 A1
(43) Pub. Date: Aug. 8, 2024

(54) LOOPABLE CHORD SEQUENCE GENERATION

(71) Applicant: Soundtrap AB, Stockholm (SE)

(72) Inventors: Francois PACHET, Stockholm (SE); Pierre ROY, Stockholm (SE)

(21) Appl. No.: 18/423,516

(22) Filed: Jan. 26, 2024

(30) Foreign Application Priority Data
Feb. 3, 2023 (EP) 23154962.7

(51) Int. Cl. G10H 1/38

(52) U.S. Cl. CPC G10H 1/38; G10H 2210/111

(57) ABSTRACT

The present disclosure relates to a method for generating a new chord sequence. The method comprises obtaining known chord sequences (S), wherein each known chord sequence has a respective known transition (T) between each pair of consecutive chords (C) in the known chord sequence. The method also comprises, among the chords of the known sequences, determining one or more new allowed transitions (N). The method also comprises, among the chords of the known chord sequences, generating a new chord sequence (L) based on there being a respective known or new allowed transition between each two consecutive chords in the new chord sequence, and the new chord sequence being loopable by there also being a known or new allowed transition between a first chord and a last chord in the new chord.

### CROSS-REFERENCE TO RELATED APPLICATIONS

This application claims priority to European application Ser. No. 23/154,962.7, filed Feb. 3, 2023, the contents of which are hereby incorporated herein in its entirety by reference.

### TECHNICAL FIELD

The present disclosure relates to obtaining a new chord sequence from a plurality of known chord sequences.

### BACKGROUND

To aid a composer in generating new music in the form of MIDI files, sets of known chord sequences are commercially available. However, such sets are limited and may unduly constrain the composer at a digital audio workstation (DAW), why there is a general need for tools for expanding the number of suitable chord sequences available to the composer.

### SUMMARY

It is an objective of the present invention to obtain a new and loopable chord sequence from among chords of already known chord sequences. Rather than only using known chord sequences, e.g., known from existing musical works, new chord sequences which may still make musical sense are generated.

According to an aspect of the present invention, there is provided a computer-implemented method for generating a new chord sequence. The method comprises, from at least one digital audio file, obtaining a plurality of known chord sequences, wherein each known chord sequence has a respective known transition between each pair of consecutive chords in the known chord sequence, and wherein each chord of the known chord sequences comprises a plurality of tones with respective pitches. The method also comprises, among the chords of the known chord sequences, determining one or more new allowed transitions, wherein a new transition from a given chord to another chord is allowed if the given chord has the same set of pitches as the other chord except for a pre-defined difference in pitch in one tone, and/or if (i) there is a known transition between the given chord and a subsequent chord and (ii) the subsequent chord has the same set of pitches as the other chord except for the pre-defined difference in pitch in one tone. The method also comprises, among the chords of the known chord sequences, generating a new chord sequence based on (i) there being a respective known or new allowed transition between each two consecutive chords in the new chord sequence and (ii) the new chord sequence being loopable by there also being a known or new allowed transition between a first chord and a last chord in the new chord sequence.

According to another aspect of the present invention, there is provided a system comprising processing circuitry, and storage storing instructions executable by said processing circuitry whereby said system is operative to perform an embodiment of the method of the present disclosure.

According to another aspect of the present invention, there is provided a computer program product comprising computer-executable components for causing a system to perform an embodiment of the method of the present disclosure when the computer-executable components are run on processing circuitry comprised in the system.

By basing the new sequence on already known sequences, typically sequences that are generally regarded as musical and thus nice to listen to for a typical person, many allowed transitions between the chords are already known. Also, the chords available for the new sequences are restricted to the chords present in the known sequences, reducing the complexity of finding the new sequences. Thus, new sequences can be found more easily and with less computer resources. By the ability to generate new chord sequences, a user is no longer constrained by limited commercially available sets of known chord sequences.

New allowed transitions between the available chords are found by identifying similar chords among the available chords. The criterion for similarity between two chords is set to a pre-defined difference in pitch, e.g., of at most one semitone in only one of the tones in the chords. Thus, the two chords should have the same number of tones and differ in pitch in only one of the tones, and the pitch difference should be as pre-defined. In practice, the pitch difference will typically be one semitone. When a pair of a first and a second similar chords has been found, there is a new allowed transition either between the two similar chords or to the second similar chord from another chord from which there already is a known allowed transition to the first similar chord in one of the known chord sequences. Thus, new allowed transitions between the available chords are identified.

With knowledge both of previously known allowed transitions among the available chords and of the newly identified allowed transitions among said available chords, the new and loopable chord sequences can be found. This may be illustrated in a graph in which the available chords are nodes and known and new transitions among the chords are arrows. A new chord sequence may then be found by following the arrows from one chord to the next chord in the new sequence until a loop is found (i.e. where there is an arrow from the last chord in the new sequence back to the first chord in the new sequence), e.g., as a cycle in the graph. That the new chord sequence is loopable thus implies that the last chord transitions smoothly, in a musical sense, to the first chord in the new sequence. The loop of the new sequence could have any number of chords as nodes, but typically the number of chords in the new sequence is within the range of 4-8 chords, e.g., 4 or 8 chords.

It is to be noted that any feature of any of the aspects may be applied to any other aspect, wherever appropriate. Likewise, any advantage of any of the aspects may apply to any of the other aspects. Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. The use of “first”, “second” etc. for different features/components of the present disclosure are only intended to distinguish the features/components from other similar features/components and not to impart any order or hierarchy to the features/components.

### BRIEF DESCRIPTION OF THE DRAWINGS

Embodiments will be described, by way of example, with reference to the accompanying drawings, in which:

FIG. 1 is a schematic representation of a chord sequence S or L, in accordance with some embodiments of the present invention.

FIG. 2 is a schematic graph illustrating known chord sequences S and known transitions T as well as new transitions N between chords C thereof as nodes in the graph, in accordance with some embodiments of the present invention.

FIG. 3 is a schematic graph illustrating determining new allowed transitions, in accordance with some embodiments of the present invention.

FIG. 4 is a schematic block diagram of a system, in accordance with some embodiments of the present invention.

FIG. 5 is a schematic flow chart of some embodiments of the method of the present invention.

### DETAILED DESCRIPTION

Embodiments will now be described more fully hereinafter with reference to the accompanying drawings, in which certain embodiments are shown. However, other embodiments in many different forms are possible within the scope of the present disclosure. Rather, the following embodiments are provided by way of example so that this disclosure will be thorough and complete, and will fully convey the scope of the disclosure to those skilled in the art. Like numbers refer to like elements throughout the description.

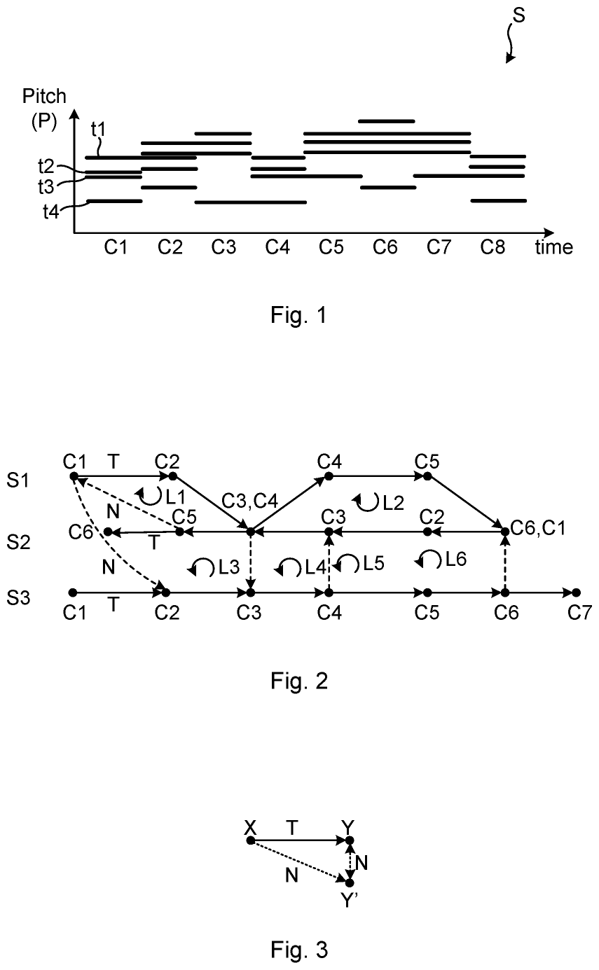

FIG. 1 illustrates a time sequence of chords C, here in a known chord sequence S but could alternatively be a new chord sequence L, e.g., as a MIDI file presented on a graphical user interface (a screen). The sequence S consists of sequential chords C, here eight chords C1, C2, C3, C4, C5, C6, C7 and C8. Each chord consists of a plurality of tones t (also called notes) to sound concurrently, e.g., four tones t1, t2, t3 and t4 as in the first chord C1. Generally, a chord as used herein is any set of pitches/frequencies that are intended to be heard simultaneously. For each chord C, the plurality of tones t may be within the range of 2-10 tones t, preferably 4-6 tones. Each tone t has a pitch P which differentiates the tone from the other tones in the same chord C. Often, but not always, each of the chords C in the sequence S (or L) is different from all the other chords in the same sequence. That a chord is different implies that it differs in the number of tones t and/or in the pitch P of one or more of its tones t.

In accordance with example embodiments, the present disclosure may involve obtaining or generating a computer-implemented model e.g., a graph model representative of one or more chord sequences. For instance, FIG. 2 illustrates some embodiments of the present disclosure in a graph in which chords C from known chord sequences S form nodes and links (also called “edges” within the field), here illustrated by arrows, indicate allowed transitions between chords, from a previous chord to a following chord, each known allowed transition T being illustrated by a solid arrow and each new allowed transition N being illustrated by a dashed arrow.

In FIG. 2, three known chord sequences S1, S2 and S3 are shown, each comprising a plurality of consecutive chords C. The first known chord sequence S1 consists of six consecutive chords: C1, C2, C3, C4, C5 and C6, which can herein be denoted as S1[C1, C2, C3, C4, C5, C6]. Similarly, the second known chord sequence S2 also consists of six consecutive chords: C1, C2, C3, C4, C5 and C6, which can herein be denoted as S2[C1, C2, C3, C4, C5, C6]. Further, the third known chord sequence S3 consists of seven consecutive chords: C1, C2, C3, C4, C5, C6 and C7, which can herein be denoted as S3[C1, C2, C3, C4, C5, C6, C7]. Within each of the known chord sequences S, solid arrows indicate the known allowed transitions T between each two consecutive chords within the known chord sequence S. Note that the third chord C3 in the first known sequence S1, which can herein be denoted C3(S1), is the same chord C, e.g., D# m in F# major, as the fourth chord C4 in the second known sequence S2, i.e. C4(S2). Also, C6(S1) is the same as C1(S2). In practice, there may be more new allowed transitions (dashed arrows) than those illustrated in FIG. 2, which may thus be regarded as simplified. For instance, a plurality of new links (dashed arrows) may extend to/from some or all of the chord nodes.

In some embodiments of the present invention, the known chord sequences may include transposed chord sequences. For instance, a known chord sequence, e.g., obtained from a received digital audio file, which is in a certain key may be transposed into corresponding known chord sequence(s) in other key(s). Typically, a total of twelve different keys may be used, whereby a received known chord sequence in one of the twelve keys is transposed to obtain respective transposed known chord sequences in the other eleven of the twelve keys.

Looking now at FIG. 3, there is a known allowed transition T from a given chord X to a subsequent chord Y. Among the chords C of the known chord sequences S there is another chord Y′ which is similar to the subsequent chord Y in that it has the same set of tones/pitches except for a pre-defined difference in pitch P in (only) one of the tones. In this case, there is a new allowed transition N (herein called a type 1 new transition), in one or both directions, between the two similar chords Y and Y′ (the subsequent chord Y and the chord Y′ which is similar to it), and/or there is a new allowed transition N (herein called a type 2 new transition) from the given chord X to the similar chord Y′. The given chord X and the subsequent chord Y are any pair of consecutive chords C in at least one of the known chord sequences S, e.g., as illustrated in FIG. 2, and the transition T therebetween is thus already known to be allowed. Since the similar chord Y′ is similar to the subsequent chord Y, it is determined that a transition from the given chord X to the similar chord Y′ is also allowed and is thus determined to be a new allowed transition N. In case of a type 1 new transition N between two similar chords Y and Y′, there is no need to consider a known transition T between a given chord X and a subsequent chord Y. For instance, a type 1 new transition N may be found even from a chord Y which is a first chord C of a known sequence S. In case both type 1 and type 2 new transitions are to be allowed, it may be convenient to first determine the type 1 new transitions N by finding any similar chords among the chords C of the known sequences S. Then, if there is a known transition T from a previous chord X to any one of the chords of a pair of similar chords Y and Y′, then there can be determined a type 2 new transition N from the previous chord X to the other one of the pair of similar chords.

Thus, new allowed transitions N are determined in the example of FIG. 2, and the new allowed transitions N are illustrated as dashed arrows in the figure. In the example of FIG. 2, only type 2 new transitions are allowed and thus determined. Taking into account both the known allowed transitions T, from the known chord sequences S, and the new allowed transitions N which have been determined among the chords of the known chord sequences S, new and loopable chord sequences L can be found. In FIG. 2 such new chord sequences L can be found by following the solid and dashed arrows to find loops with a desired number of chords/nodes C, e.g., Hamiltonian cycles. In the example of FIG. 2, six new and loopable chord sequences L are schematically indicated:

### L1 [C1(S1), C2(S1), C3(S1), C5(S2)];

### L2 [C3(S1), C4(S1), C5(S1), C6(S1), C2(S2), C3(S2)];

### L3 [C3(S2), C4(S2), C5(S2), C1(S1), C2(S3), C3(S3), C4(S3)];

### L4 [C3(S2), C4(S2), C3(S3), C4(S3)];

### L5 [C1(S2), C2(S2), C3(S2), C4(S2), C5(S2), C1(S1), C2(S3), C3(S3), C4(S3), C5(S3), C6(S3)]; and

### L6 [C1(S2), C2(S2), C3(S2), C4(S2), C3(S3), C4(S3), C5(S3), C6(S3)].

If a chord is allowed to occur more than once in the same new chord sequence L, a seventh new and loopable chord sequence L7 may be found as a combination of L1 and L2, as L7 [C1(S1), C2(S1), C3(S1), C4(S1), C5(S1), C6(S1), C2(S2), C3(S2), C4(S2), C5(S2)]. Since C3(S1) is the same chord as C4(S2), that chord occurs twice in the seventh new sequence L7. This makes the seventh new sequence L7 non-Hamiltonian, which may or may not be desired in some embodiments of the present disclosure.

A new and loopable chord sequence L can have any number of consecutive chords, one after the other in sequence before starting over in the loop, i.e. the chord which occurs twice in the seventh new sequence L7 is counted twice, and the chords can be illustrated as nodes of a cycle in a graph as in FIG. 2. However, typically a suitable new chord sequence L consists of 4-8 chords, such as all the new sequences L1-L7 except the fifth new sequence L5 and the seventh new sequence L7. For musical reasons, new sequences L of 4 chords, such as L1 and L4, and/or of eight chords, such as L6, may be preferred.

Since the new sequences L are loopable, it is in theory an arbitrary choice which of the chords C there in that is regarded as the first chord and which that is regarded as the last chord of the new sequence. In practice, however, a new sequence L is typically defined, e.g., in a MIDI file, as a sequence of consecutive chords from a first chord to a last chord, but where a transition from the last chord back to the first chord is allowed, either as a known allowed transition T or a new allowed transition N. Based on musical considerations, the present disclosure may involve defining a chord C as a first chord in a new sequence L if said chord is also a first chord C1 in one of the known sequences S.

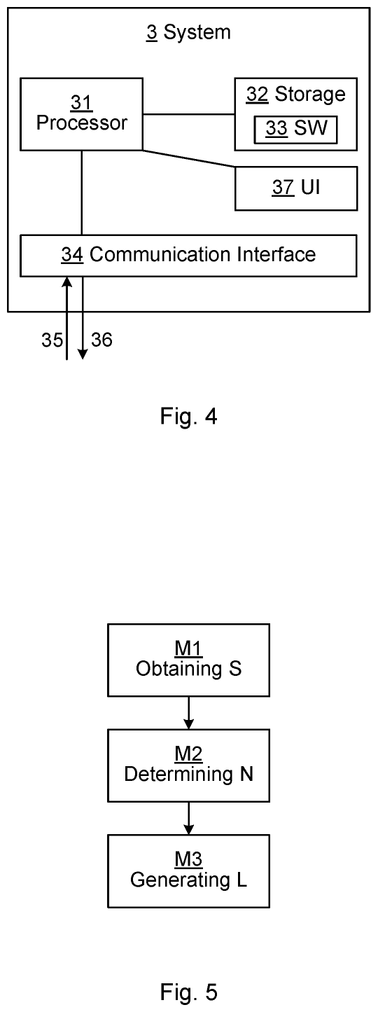

FIG. 4 illustrates an embodiment of a system 3 for editing audio files, e.g., comprised in a DAW, for instance a MIDI editor for editing Musical Instrument Digital Interface (MIDI) digital computer files. Embodiments of such a system 3 may be used for performing an embodiment of the method of the present disclosure. The system 3 comprises processing circuitry 31 e.g., a central processing unit (CPU). The processing circuitry 31 may 31 may comprise one or a plurality of processing units in the form of microprocessor(s). However, other suitable devices with computing capabilities could be comprised in the processing circuitry 31, e.g., an application specific integrated circuit (ASIC), a field programmable gate array (FPGA) or a complex programmable logic device (CPLD). The processing circuitry 31 is configured to run one or several computer program(s) or software (SW) 33 stored in a data storage 32 of one or several storage unit(s) e.g., a memory. The storage unit is regarded as a computer readable means or medium 32, forming a computer program product together with the SW 33 stored thereon as computer-executable components, and may e.g., be in the form of a Random Access Memory (RAM), a Flash memory or other solid state memory, or a hard disk, or be a combination thereof. The processing circuitry 31 may also be configured to store data in the storage 32, as needed. The system 3 may also comprise a digital communication interface 34, e.g., for receiving respective MIDI files of the known chord sequences S as input 35 and for outputting a MIDI file of the new chord sequence L as output 36. The system 3 may conveniently comprise a user interface 37, e.g., comprising a touch display, for presenting information to a user of the system and/or for receiving input from the user.

In some embodiments, the new chord sequence L may be selected based on a criterion received from a user via the user interface 37. Such a criterion may e.g., be or comprise any of:

number of chords C in the new sequence L,
number of scales used in the new sequence L,
number of modulations (transitions between scales) in the new sequence L,
specific scale(s) used or types of chords (e.g., C major/minor) in the new sequence L,
number of occurrences of a particular type of chord (e.g., one diminished chord at most), and/or allowing type 1 and/or type 2 new transitions N.
In some embodiments of the present invention, the criterion includes an indication of one or more of: key(s), scale(s), and/or number of modulation(s). Additionally or alternatively, at least one chord sequence may be selected from an updated set of chord sequences based on satisfying the user-defined criterion. In some embodiments, the at least one selected chord sequence may be or include the generated new chord sequence L. The updated set of chord sequences may include the plurality of new and loopable chord sequences generated, and may also include the plurality of known chord sequences S.

The criterion may be used to select the new chord sequence L to generate, from a plurality of possible new and loopable chord sequences which can be found among the chords C of the known sequences S. In some embodiments, the plurality of new and loopable chord sequences consists of some or all possible new and loopable chord sequences which can be found among the chords C of the known sequences S, i.e. each having a respective known or new allowed transition T or N (type 1 and/or type 2) between each two consecutive chords in the new and loopable chord sequence. Thus, the system 3 may first find the plurality of possible new and loopable chord sequences, after which one of them is selected to be generated based on the criterion (e.g., a brute-force approach). In some embodiments of the present invention, the generating of a new chord sequence L comprises generating the new chord sequence L to satisfy the user-defined criterion. In some embodiments, the generating of the new chord sequence L comprises finding a plurality of new and loopable chord sequences, possibly all possible new and loopable chord sequences, and selecting the new chord sequence L based on the user-defined criterion from the plurality of new and loopable chord sequences.

In some embodiments of the present invention, Constraint Satisfaction (so called Constraint Satisfaction Problem, CSP) is used for finding the possible new and loopable chord sequences. This is a technology that is used for solving discrete combinatorial problems. Below follows an example on how a CSP may be defined, e.g., by the system 3.

A number of constrained variables, v1, v2, . . . , vn (as many as the length of the sequence L, e.g., 4, 8, etc.) are instantiated. Each constrained variable has a domain, which is the set of all the nodes in the graph. Then are added:
“Binary constraints” between vi and vi+1 such that there is an edge between the value of vi and the value of vi+1. In order to get a cycle (loopable sequence), the binary constraint is added between vn and v1.
An AllDiff constraint holding on v1, v2, . . . vn to ensure that all nodes (chords) are different. The AllDiff constraint is well known in the field (see the global constraint catalogue for instance).
Possibly an nValue constraint (see also the global constraint catalogue) replacing the allDiff constraint, to ensure that there are “n” distinct values (not necessarily as many as there are chords in the sequence, i.e. allowing some repetition).

Possibly unary constraints on specific chords at specific positions (e.g., the first and last chord should be “major” chords).

Possibly nValue constraints holding on the types of chords. For instance, “2 chords should be diminished”, etc.

In some embodiments of the present invention, a harmonic analysis is performed on at least one, some or all, preferably all, found possible new and loopable chord sequences.

Additionally, in some embodiments, the harmonic analysis may also be made on one, some or all, preferably all, known chord sequences S, preferably including any transposed versions of the known chord sequences. Information about results of the harmonic analysis of a possible new chord sequence may be stored together with said possible new chord sequence, e.g., as metadata, for instance in the storage 32 of the system 3. Such results for each possible new chord sequence may include information about e.g., key(s), scale(s) and/or number of modulations etc. In some embodiments, the harmonic analysis is based on dynamic programming, e.g., in order to minimize the number of scale changes. Below follows an example of such harmonic analysis, e.g., performed by the system 3.
Input: a chord sequence
Output: a list of analysis for each chord of the sequence
An analysis comprises 1) a scale and 2) a degree in that scale
Note: considered may be e.g., 36 possible scales, i.e. C, C#, D, etc. (12 pitch classes) in major, minor and harmonic minor (though more scales may be used if needed).
Given a chord sequence s=C1, C2, . . . , C_{N}
For each chord Ci the probability of Ci belonging to each of the 36 scales is computed. This probability may be based on comparing the pitch histogram of the scale (e.g., as specified by Krumhansl, Carol. Cognitive Foundations of Musical Pitch, July 1992, Music Perception 9(4):476-492) to the pitch histogram of the chord using a cosine distance.

Then a dynamic programming algorithm may be used to compute the sequence of scales k1, k2, . . . , k_{N} that maximizes the product of the probabilities of Ci to belong to ki. Also unitary costs may be considered (this is standard practice in dynamic programming) to penalize modulations, i.e. changes of scales: ki≠ki+1. The resulting sequence may be the best compromise of the analysis, e.g., in that it has both a high probability for each chord and minimizes the number of modulations (i.e. transitions between scales).The new chord sequence L may be selected on a criterion related to the results of the harmonic analysis. Thus, in some embodiments, the selecting of the new chord sequence L, from the plurality of found new and loopable chord sequences, based on the user-defined criterion includes reviewing the stored information resulting from the harmonic analysis of the new and loopable chord sequence to determine that the criterion is satisfied.

FIG. 5 illustrates some embodiments of the method of the present disclosure. The method is a computer-implemented method for generating a new chord sequence L. A plurality of known chord sequences S are obtained M1 from at least one digital audio file, e.g., MIDI file. Each of the known chord sequences has a respective known transition T between each pair of consecutive chords in the sequence. Each chord C of the known chord sequences S comprises or consists of a plurality of tones t, where each tone t has a specific pitch P. Among the chords C of the known chord sequences S, one or more new allowed transitions N are determined M2. As discussed above, there are two types (type 1 and type 2) of new transitions which may be allowed, alone or in combination, in different embodiments of the present invention. Thus, in some embodiments, a new transition from a given chord to another chord is allowed if the given chord Y has the same set of pitches as the other chord Y′ except for a pre-defined difference in pitch P in one tone. Additionally or alternatively, in some embodiments of the present invention, a new transition from a given chord to another chord is allowed if (i) there is a known transition T between the given chord X and a subsequent chord Y and (ii) the subsequent chord has the same set of pitches as the other chord Y′ except for the pre-defined difference in pitch P in one tone. The predefined difference may be one semitone or at most one semitone. Then, a new chord sequence L is generated M3 from among the chords C of the known chord sequences S. The new chord sequence is generated M3 based on (i) there being a respective known or new allowed transition T and/or N between each two consecutive chords in the new chord sequence L, and (ii) the new chord sequence being loopable by there also being a known or new allowed transition between a first chord C1 and a last chord in the new chord sequence L.

In some embodiments, the new chord sequence L is stored, e.g., in the storage 32 of the system 3. The new chord sequence L may then be presented via a UI, e.g., the UI 37 of the system 3. In some embodiments, the new chord sequence L is presented via a UI of a DAW, e.g., a DAW comprising the system 3.

In some embodiments, the obtaining M1 the plurality of known chord sequences comprises generating a computer-implemented model comprising (i) nodes that respectively represent chords C in the known chord sequences S and (ii) initial links between nodes that respectively represent known transitions T. Then, the determining M2 of the one or more new allowed transitions N may comprise adding one or more new links between nodes to the model, where each such new link represents one of the one or more new allowed transitions N. The thus obtained model may be illustrated by a graph as in FIG. 2.

The system 3 may be used for performing embodiments of the method of the present disclosure. In some embodiments, the present disclosure provides a non-transitory computer readable medium 32 comprising computer-executable components 33 for causing a system 3 to perform an embodiment of the method of the present disclosure when the computer-executable components are run on processing circuitry 31 comprised in the system. For example, the computer-executable components 33 may cause the system 3 to, from at least one digital audio file, obtain M1 a plurality of known chord sequences S, wherein each known chord sequence has a respective known transition T between each pair of consecutive chords in the known chord sequence, and wherein each chord C of the known chord sequences comprises a plurality of tones t with respective pitches P. The computer-executable components 33 may also cause the system 3 to, among the chords C of the known chord sequences S, determine M2 one or more new allowed transitions N, wherein a new transition from a given chord to another chord is allowed if the given chord Y has the same set of pitches as the other chord Y′ except for a pre-defined difference in pitch P in one tone, and/or if (i) there is a known transition T between the given chord X and a subsequent chord Y and (ii) the subsequent chord has the same set of pitches as the other chord Y′ except for the pre-defined difference in pitch P in one tone. The computer-executable components 33 may also cause the system 3 to, among the chords C of the known chord sequences S, generate M3 a new chord sequence L based on (i) there being a respective known or new allowed transition T and/or N between each two consecutive chords in the new chord sequence and (ii) the new chord sequence being loopable by there also being a known or new allowed transition between a first chord C1 and a last chord C4/C5/C6/C7/C8 in the new chord sequence.

In some embodiments, the method is performed by a system 3 for editing digital audio files, e.g., a MIDI editor, receiving the at least one digital audio file of the known chord sequences S as input 35 and/or outputting 36 a digital audio file of the new chord sequence L.

In some embodiments, the at least one digital audio file comprises a respective digital audio file for each of the known chord sequences S. In some embodiments, each of the at least one digital audio file is provided as a MIDI file. In some embodiments, the generated M3 new chord sequence L is obtained as a digital audio file, e.g., a MIDI file. The digital audio file of the new chord sequence L may then be stored, e.g., in the storage 32 of the system 3.

In some embodiments of the present invention, the method comprises generating a plurality of new and loopable chord sequences, each having a respective known or new allowed transition T or N between each two consecutive chords, thereby resulting in an updated set of chord sequences that includes (i) the plurality of known chord sequences S and (ii) the plurality of new and loopable chord sequences. The generating of the plurality of new and loopable chord sequences may comprise the generating M3 of the new chord sequence L. In some embodiments, the method comprises obtaining a user-defined criterion via the user interface 37. The user-defined criterion may comprise an indication of one or more of: number of chords C, number of scales used, number of modulations, specific scale(s) used, types of chords, number of occurrences of a particular type of chord, allowing type 1 and/or type 2 new transitions N. Then the method may comprise selecting at least one chord sequence from the updated set of chord sequences based to satisfy the obtained user-defined criterion. Additionally or alternatively, in some embodiments, the method comprises performing harmonic analysis on one or more sequences in the updated set of chord sequences, resulting in information about the one or more sequences, e.g., about respective key(s), scale(s) and/or number of modulations of the one or more sequences. The information may then be stored together with the updated set of chord sequences, e.g., as metadata. In some embodiments, after performing the harmonic analysis, the method comprises obtaining a user-defined criterion via the user interface 37, wherein the criterion includes an indication of one or more of: particular key(s), scale(s), and/or number of modulation(s). Then, the selecting of at least one chord sequence from the updated set of chord sequences may be based on satisfying the user-defined criterion. In some embodiments, the method comprises, after determining the one or more new allowed transitions, applying computer-implemented Constraint Satisfaction to generate the plurality of new and loopable chord sequences.

The present disclosure has mainly been described above with reference to a few embodiments. However, as is readily appreciated by a person skilled in the art, other embodiments than the ones disclosed above are equally possible within the scope of the present disclosure, as defined by the appended claims.

1. A computer-implemented method for generating a new chord sequence, the method comprising:
from at least one digital audio file, obtaining (M1) a plurality of known chord sequences (S), wherein each known chord sequence has a respective known transition (T) between each pair of consecutive chords in the known chord sequence, and wherein each chord (C) of the known chord sequences comprises a plurality of tones (t) with respective pitches (P);
among the chords (C) of the known chord sequences (S), determining (M2) one or more new allowed transitions (N), wherein a new transition from a given chord to another chord is allowed
if the given chord (Y) has the same set of pitches as the other chord (Y′) except for a pre-defined difference in pitch (P) in one tone, and/or
if i) there is a known transition (T) between the given chord (X) and a subsequent chord (Y) and ii) the subsequent chord has the same set of pitches as the other chord (Y′) except for the pre-defined difference in pitch (P) in one tone;
among the chords (C) of the known chord sequences (S), generating (M3) a new chord sequence (L) based on i) there being a respective known or new allowed transition (T/N) between each two consecutive chords in the new chord sequence and ii) the new chord sequence being loopable by there also being a known or new allowed transition (T/N) between a first chord (C1) and a last chord (C4/C5/C6/C7/C8) in the new chord sequence.

2. The method of claim 1, wherein the pre-defined difference in pitch is at most one semitone, preferably the pre-defined difference in pitch is one semitone.

3. The method of claim 1,
wherein obtaining (M1) the plurality of known chord sequences comprises generating a computer-implemented model comprising i) nodes that respectively represent chords (C) in the known chord sequences (S) and ii) initial links between nodes that respectively represent known transitions (T); and
wherein determining (M2) one or more new allowed transitions (N) comprises adding one or more new links between nodes to the model that respectively represent the one or more new allowed transitions.

4. The method of claim 1 performed by a system (3) receiving the at least one digital audio file of the known chord sequences (S) as input (35) and outputting (36) a digital audio file of the new chord sequence (L).

5. The method of claim 1, wherein the at least one digital audio file comprises a respective digital audio file for each of the known chord sequences (S).

6. The method of claim 1, wherein each of the at least one digital audio file is provided as a MIDI file.

7. The method of claim 1, wherein generating (M3) the new chord sequence (L) comprises generating a digital audio file, e.g., a MIDI file, representative of the new chord sequence (L).

8. The method of claim 1 further comprising:
generating a plurality of new and loopable chord sequences, each having a respective known or new allowed transition (T/N) between each two consecutive chords, thereby resulting in an updated set of chord sequences that includes i) the plurality of known chord sequences (S) and ii) the plurality of new and loopable chord sequences;
wherein generating the plurality of new and loopable chord sequences comprises the generating (M3) of the new chord sequence (L).

9. The method of claim 8 further comprising:
obtaining a user-defined criterion via a user interface (37), wherein the user-defined criterion comprises an indication of one or more of:
number of chords (C),
number of scales used,
number of modulations,
specific scale(s) used,
types of chords,
number of occurrences of a particular type of chord, and
allowing type 1 and/or type 2 new transitions N; and
selecting at least one chord sequence from the updated set of chord sequences based on satisfying the user-defined criterion.

10. The method of claim 8 further comprising:
performing harmonic analysis on one or more sequences in the updated set of chord sequences, resulting in information about the one or more sequences, e.g., about respective key(s), scale(s) and/or number of modulations of the one or more sequences; and
storing the information together with the updated set of chord sequences, e.g., as metadata.

11. The method of claim 10 further comprising:
after performing the harmonic analysis, obtaining a user-defined criterion via a user interface (37), wherein the criterion includes an indication of one or more of: particular key(s), scale(s), and/or number of modulation(s); and
selecting at least one chord sequence from the updated set of chord sequences based on satisfying the user-defined criterion.

12. The method of claim 8 further comprising:
after determining the one or more new allowed transitions, applying computer-implemented Constraint Satisfaction to generate the plurality of new and loopable chord sequences.

13. The method of claim 1, wherein each of the chords (C) in the new chord sequence (L) is different from the other chords in said new chord sequence.

14. A system (3) comprising:
processing circuitry (31); and
storage (32) storing instructions (33) executable by said processing circuitry (31) whereby said system (3) is operative to perform the method of claim 1

15. A computer program product (32) comprising computer-executable components (33) for causing a system (3) to perform the method of claim 1 when the computer-executable components are run on processing circuitry (31) comprised in the system.
